(19) United States
(12) Patent Application Publication
(10) Pub. No.: US 2012/0086924 A1
(43) Pub. Date: Apr. 12, 2012

(54) AUTO FOCUSING MOBILE PROJECTOR AND METHOD THEREOF

(75) Inventors: Kang-Young MOON, Yongin-si (KR); Yong-Chan Keh, Seoul (KR); Gyu-Bong Lee, Suwon-si (KR)

(73) Assignee: Samsung Electronics Co., Ltd., Suwon-si (KR)

(21) Appl. No.: 13/270,549

(22) Filed: Oct. 11, 2011

(30) Foreign Application Priority Data
Oct. 8, 2010 (KR) 10-2010-0098366

(51) Int. Cl. G03B 3/00

(52) U.S. Cl. 353/101; 353/121

(57) ABSTRACT

A mobile projector and method are provided for performing Auto Focusing (AF). The mobile projector includes a projection system for projecting an image onto a screen, a camera module for receiving an input image which is the projected image, an edge detection logic for detecting an edge value of the input image, and a controller for controlling the edge detection logic to detect the edge value of the input image, and controlling focusing of the mobile projector based on the edge value.

### PRIORITY

This application claims priority under 35 U.S.C. §119(a) to Korean Patent Application Serial No. 10-2010-0098366, which was filed in the Korean Intellectual Property Office on Oct. 8, 2010, the entire disclosure of which is hereby incorporated by reference.

### BACKGROUND OF THE INVENTION

1. Field of the Invention

The present invention relates generally to auto focusing, and more particularly to, a method for automatically performing a focusing function of a mobile projector.

2. Description of the Related Art

A projection-type display device, i.e., a projector, projects an image, e.g., a picture or a scene, to be displayed onto a screen using an optical lens. More specifically, the projector projects an image onto the screen through a lens module including a focusing lens, and focuses the projected image using the focusing lens. However, when the position of the projector or the screen changes, the projector will then refocus the projected image using the focusing lens for better viewing, i.e., a clearer projected image. That is, as a position of the projector changes, the focus of the focusing lens also must change, often by manually turning the lens module to move the focusing lens back and forth, or by pushing a button to rotate a focus lens transfer motor, which similarly moves the focusing lens back and forth.

FIG. 1 is a block diagram illustrating a conventional projector capable of performing focusing.

Referring to FIG. 1, the projector includes a projection system 101, a switchover circuit 103, a memory 105, an Auto Focusing (AF) switch 107, and a controller 109. The projection system 101 projects an image signal onto a screen. The projection system 101 includes a focusing lens for adjusting the focus of an image projected onto the screen.

Under control of the controller 111, the switchover circuit 103 cuts off a currently projected image signal to project a pattern image for performing AF. Upon completion of AF, the switchover circuit 103 then cuts off the currently projected pattern image to project the previous image signal under the control of the controller 111.

The memory 105 stores the pattern image to provide that image upon receiving a request for the pattern image from the switchover circuit 103. The controller 109, upon receiving an AF request signal from the AF switch 107, controls the switchover circuit 103 to project the pattern image stored in the memory 105 instead of the currently projected image signal, and then adjusts the focusing lens of the projection system 101 to focus the pattern image.

FIGS. 2A and 2B illustrating a focusing process of a conventional projector. Specifically, in the focusing process illustrated in FIGS. 2A and 2B, upon input of an AF request signal for facilitating focusing, AF is performed by projecting a pattern image, as illustrated in FIG. 2B, instead of a currently projected image signal, as illustrated in FIG. 2A.

Referring to FIG. 2A, a projector 201 projects an image signal onto a screen 203. For example, the image signal may be received and projected from an electronic device such as a computer, and may be a still image or a moving image.

Referring to FIG. 2B, the projector 201, upon receiving an AF request signal while projecting the image signal onto the screen 203, cuts off the projected image signal illustrated in FIG. 2A and projects a pattern image to perform AF.

Conventionally, projectors have been relatively expensive equipment and mainly used for conferences, education, or events in public places such as large conference rooms. Recently, however, home projectors have become more commonly used. Further, with the advanced development of mobile terminals such as cellular phones, highly portable compact projectors, which may be mounted on mobile terminals or conveniently carried in bags, have been released in the market.

However, these compact portable projectors have some limitations in their ability to focus in a conventional manner. That is, when a focusing lens is adjusted manually in the conventional manner, of the movement of the focusing lens depends on the user who controls the projector. As a result, it is often difficult to perform an accurate adjustment of the focusing lens through a single manipulation.

Also when performing AF, projecting a pattern image onto the screen requires additional circuits and time. Further, there is inconvenience created by the pattern image being projected during AF, instead of a desired image. In particular, this inconvenience is often exacerbated by a mobile projector, which tends to frequently change a projection position, and thus, more often uses an AF function, inconveniencing the user.

### SUMMARY OF THE INVENTION

Accordingly, the present invention has been made to solve the above-mentioned problems occurring in the prior art, and to provide at least the advantages described below.

An aspect of the present invention is to provide an apparatus and method for performing AF without a separate picture change (or switchover) during the AF, by detecting an edge value of a projection region with a separate camera module, instead of using a pattern image.

In accordance with an aspect of the present invention, a mobile projector capable of performing AF is provided. The mobile projector includes a projection system for projecting an image onto a screen, a camera module for receiving an input image comprising the projected image, an edge detection logic for detecting an edge value of the input image, and a controller for controlling the edge detection logic to detect the edge value of the input image, and controlling focusing of the mobile projector based on the edge value.

In accordance with another aspect of the present invention, a method is provided for performing AF using a mobile projector. The method includes projecting an image onto a screen, receiving an input image including the projected image, detecting an edge value of the input image, and focusing the mobile projector based on the edge value.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram illustrating a conventional projector capable of performing focusing;

FIGS. 2A and 2B illustrate a focusing process of a conventional projector;

FIG. 3 is a block diagram illustrating a mobile projector for performing focusing according to an embodiment of the present invention;

FIG. 4 illustrates an input image including a full projection region and an edge detection region larger than the projection region according to an embodiment of the present invention; and

FIG. 5 is a flowchart illustrating an AF process of a mobile projector according to an embodiment of the present invention.

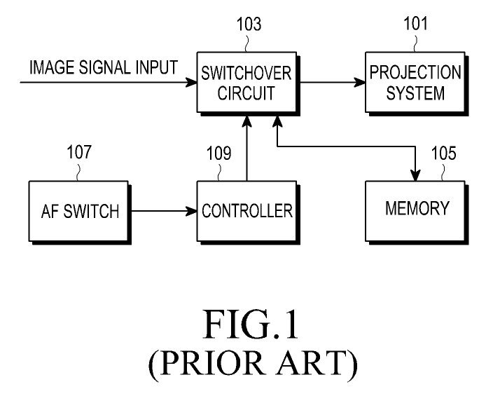

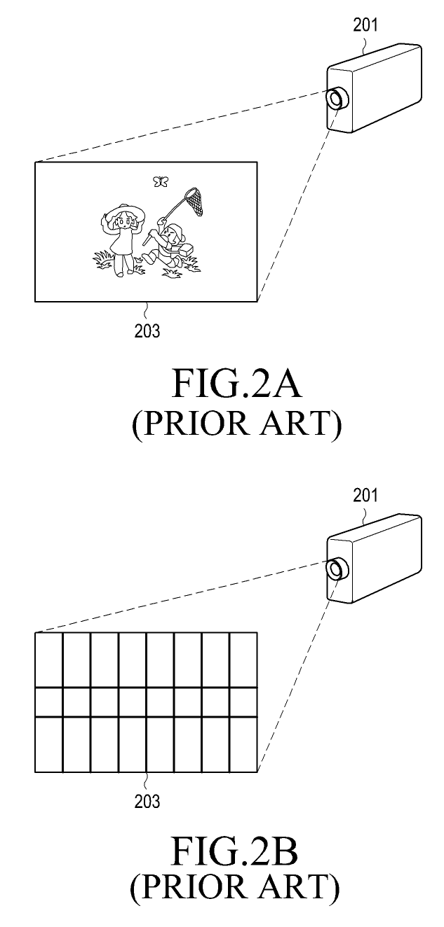

### DETAILED DESCRIPTION OF THE EMBODIMENTS OF THE INVENTION

Various embodiments of the present invention will be described in detail below with reference to the accompanying drawings. In the following description, specific details such as detailed configuration and components are merely provided to assist the overall understanding of these embodiments of the present invention, and therefore, it should be apparent to those skilled in the art that various changes and modifications of the embodiments described herein can be made without departing from the scope and spirit of the invention.

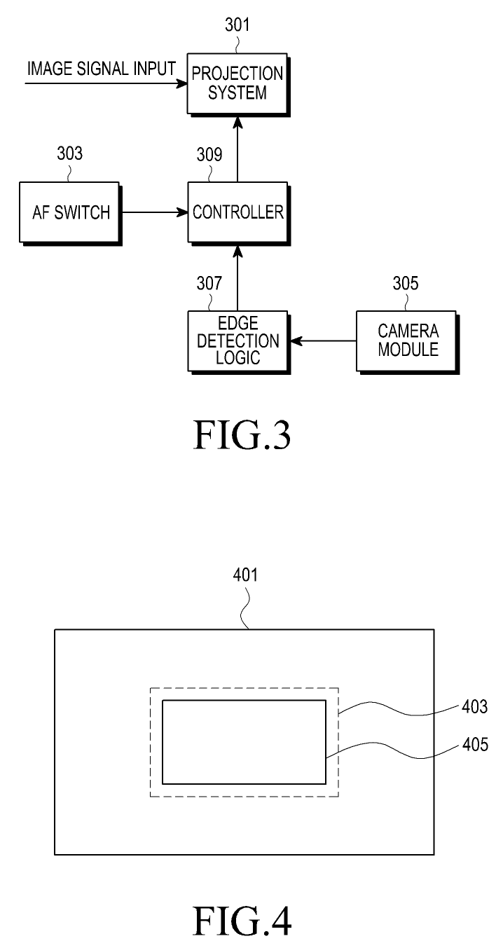

FIG. 3 is a block diagram illustrating a mobile projector for performing focusing according to an embodiment of the present invention.

Referring to FIG. 3, the mobile projector includes a projection system 301, an AF switch 303, a camera module 305, an edge detection logic 307, and a controller 309. The projection system 301 projects an image signal onto a screen, and includes a focusing lens for adjusting the focus of an image projected onto the screen. The focusing lens is driven in connection with the camera module 305 and the controller 309.

The camera module 305 receives the image projected onto the screen through the projection system 301 as an input image. The viewing angle of the camera module 205 is generally larger than that of the projection system 301, such that the camera module 305 can receive the image projected through the projection system 301 as the input image. For easy reception, the mounting position of the camera module 305 is preferably adjacent to the projection system 301.

The edge detection logic 307 analyzes the input image received by the camera module 305 to detect an edge value. The input image includes a projection region projected onto the screen, and the edge detection logic 307 detects an edge value from an edge detection region in the input image. Because the edge detection region has a large picture-size change in a focusing process due to the nature of the mobile projector, the edge detection region is a region that includes the projection region and is larger than the projection region. In the case of an empty picture, which has no input image, the edge detection logic 307 detects an outer edge value of the projection region and transmits the outer edge value to the controller 309.

For efficient image detection during AF, the exposure time of the camera module 305 is adjusted under control of the controller 309. Basically, because the camera module 305 may receive an input image that is either a too bright or dark according to ambient brightness and a projection distance, the exposure time of the camera module 305 is adjusted so that the edge detection logic 307 can receive an optimal input image.

The controller 309, upon sensing an input from the AF switch 303, analyzes the input image received by the camera module 305, calculates an optimal exposure time, and controls the edge detection logic 307 to apply the optimal exposure time to the camera module 305, such that the camera module 305 can receive the optimal input image. The controller 309 also receives the edge value analyzed by the edge detection logic 307 to move the focus lens included in the projection system 301 to a position in which the edge value reaches a peak (or maximum) value.

When the received input image is a moving image, the controller 309 temporarily stops the moving image to move the focusing lens. Accordingly, the focusing lens may be controlled during reproduction of the moving image. However, during reproduction of the moving image, edge value configuration of the picture may frequently change, which often makes edge value detection difficult. Therefore, when a moving image is reproduced, the moving image is paused and the position of the focus lens is determined using the paused image.

While the projection system 301 and the camera module 305 are illustrated as separate components in FIG. 3, the camera module 305 may be included in the projection system 301.

FIG. 4 illustrates an input image including a full projection region and an edge detection region, which is larger than the projection region, according to an embodiment of the present invention.

Referring to FIG. 4, a camera capture region 401 corresponding to the input image received by the camera module 305 includes a projection region 405 corresponding to an image projected onto the screen and an edge detection region 403 for detecting an edge value of the projection region 405. In accordance with an embodiment of the present invention, due to a large picture-size change with AF, when AF is performed with an arbitrary picture, an edge value is detected in the full projection region 405.

Because the input image 403 includes the projection region 405 projected onto the screen, the edge detection logic 307 detects an edge value in the edge detection region 403. At this time, the size of the projection region 405 may change due to focus adjustment, and therefore, a region which includes the projection region 405 and will be larger than the projection region 405 by a particular portion is set as the edge detection region 403.

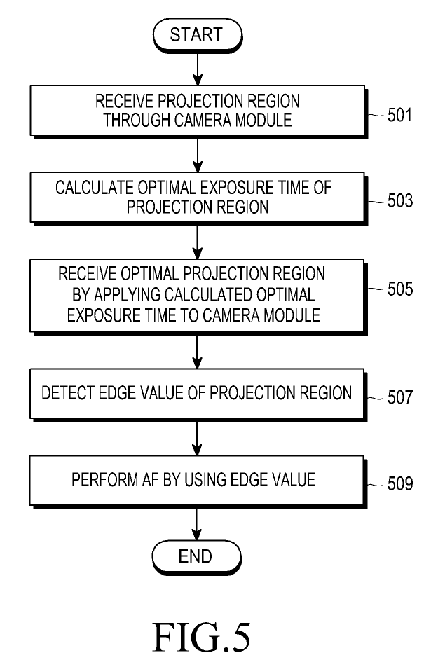

FIG. 5 is a flowchart illustrating an AF process of a mobile projector according to an embodiment of the present invention.

Referring to FIG. 5, in step 501, upon receipt of an AF request signal while projecting an image onto a screen, the mobile projector receives the projected image as an input image, using the camera module 305. The camera module 305 may be mounted separately from a general camera module mounted on a mobile terminal. Because the viewing angle of the camera capture region 401 corresponding to the input image received by the camera module 305 is larger than the viewing angle of the projection region 405 corresponding to the image projected by the projection system 301 of the mobile projector, the camera module 305 can sufficiently receive the image projected by the projection system 301 as the input image. For smooth reception, the camera module 305 is mounted adjacent to the projection system 301.

In step 503, the mobile projector calculates an optimal exposure time of the projection region 405 included in the received camera capture region 401 by using the edge detection logic 307. Because the camera module 305 may receive an input image that is either too bright or too dark, based on ambient brightness and a projection distance, the mobile projector calculates the exposure time of the camera module 305 such that the edge detection logic 307 can receive an optimal input image.

In step 505, the mobile projector applies the optimal exposure time, which is calculated by controlling the edge detection logic 307, to the camera module 305, such that the camera module 305 can receive the optimal input image.

In step 507, the mobile projector detects an edge value by analyzing the edge detection region 403 in the received camera capture region 401. As described above, a picture size may change with the focusing lens movement, and therefore, a region that includes the projection region 405 and is larger than the projection region 405 is set as the edge detection region 403.

In step 509, the mobile projector receives the edge value analyzed by the edge detection logic 307 and moves the focusing lens included in the projection system 301 to a position in which the edge value reaches a peak value. When the received input image is a moving image, the moving image may be temporarily paused to move the focusing lens.

As can be appreciated from the foregoing description, a projection region is received by a separate camera module and AF is performed by detecting an edge value in the received projection region, such that picture switchover to a pattern image is not required and the time required for performing AF can be reduced. Additionally, AF can be easily performed, even when there is a large picture-size change.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A mobile projector for performing Auto Focusing (AF), the mobile projector comprising:
a projection system for projecting an image onto a screen;
a camera module for receiving an input image comprising the projected image;
an edge detection logic for detecting an edge value of the input image; and
a controller for controlling the edge detection logic to detect the edge value of the input image, and controlling focusing of the mobile projector based on the edge value.

2. The mobile projector of claim 1, wherein the projection system comprises a focusing lens for focusing the projected image.

3. The mobile projector of claim 2, wherein the controller controls the focusing of the mobile projector by moving the focusing lens to a position at which the edge value reaches a peak value.

4. The mobile projector of claim 1, wherein the input image comprises:
a projection region corresponding to the projected image; and
an edge detection region including the projection region.

5. The mobile projector of claim 1, wherein the edge detection region is larger than the projection region by a preset size.

6. The mobile projector of claim 1, wherein the controller controls the edge detection logic to calculate an exposure time of the camera module according to ambient brightness of the projected image and a projection distance to the screen, and applies the exposure time to the camera module.

7. The mobile projector of claim 6, wherein the edge detection logic detects an edge value of the edge detection region included in the input image received from the camera module, after application of the exposure time.

8. The mobile projector of claim 1, wherein when the projected image is a moving image, the controller pauses the moving image and controls the camera module to receive the input image including the paused image.

9. The mobile projector of claim 1, wherein the camera module is disposed adjacent to the projection system.

10. A method for performing Auto Focusing (AF) by a mobile projector, the method comprising:
projecting an image onto a screen;
receiving an input image including the projected image;
detecting an edge value of the input image; and
focusing the mobile projector based on the edge value.

11. The method of claim 10, wherein the input image includes a projection region corresponding to the projected image and an edge detection region, which includes the projection region.

12. The method of claim 11, wherein the edge detection region is larger than the projection region by a preset size.

13. The method of claim 10, wherein detecting the edge value comprises:
calculating an exposure time according to ambient brightness of the projected image and a projection distance to the screen; and
detecting the edge value using the exposure time.

14. The method of claim 13, wherein detecting the edge value using the calculated exposure time comprises detecting an edge value of the edge detection region included in the input image received, after application of the exposure time.

15. The method of claim 10, further comprising, when the projected image is a moving image, pausing the moving image; and
receiving the input image including the paused image.

16. The method of claim 10, wherein focusing the mobile projector comprises moving a focusing lens included in the mobile projector to a position at which the edge value reaches a peak value.
